(19) United States
(12) Patent Application Publication
(10) Pub. No.: US 2020/0326293 A1
(43) Pub. Date: Oct. 15, 2020

(54) INTEGRATED, MINIATURIZED, WIRELESS SENSING ELECTRONIC PLATFORM FOR HIGH RESOLUTION GAS SENSING

(71) Applicant: Carrier Corporation, Palm Beach Gardens, FL (US)

(72) Inventors: Dimitrios Peroulis, West Lafayette, IN (US); Xiaofan Jiang, West Lafayette, IN (US)

(21) Appl. No.: 16/844,177

(22) Filed: Apr. 9, 2020

Related U.S. Application Data
(60) Provisional application No. 62/831,911, filed on Apr. 10, 2019.

(51) Int. Cl. G01N 27/04

(52) U.S. Cl. CPC G01N 27/045; G01N 27/046

(57) ABSTRACT

An electronic sensing system located on a printed circuit board is provided. The electronic sensing system including: a target gas sensor configured to detect a resistance of the target gas sensor; a reference sensor configured to detect a resistance of the reference sensor; a resistance comparator including a digital potentiometer, the resistance comparator being electrically connected to the target gas sensor and the reference sensor, wherein the digital potentiometer is configured to be adjusted to determine a first resistance in response to the resistance of the target gas sensor and a second resistance in response to the resistance of the reference sensor; and a system on a chip in electronic communication with the resistance comparator, the system on a chip being configured to determine a target gas concentration in response to the first resistance and the second resistance.

### CROSS-REFERENCE TO RELATED APPLICATIONS

This application claims the benefit of Provisional Application No. 62/831,911 filed Apr. 10, 2019, the disclosure of which is incorporated herein by reference in its entirety.

### BACKGROUND

The subject matter disclosed herein generally relates to the gas sensing, and more particularly to an apparatus and method for sensing gas.

Detection of a target gas (e.g., ethylene) is often difficult in the presence of contaminants, such as, for example, carbon dioxide and carbon monoxide.

### BRIEF SUMMARY

According to one embodiment, an electronic sensing system located on a printed circuit board is provided. The electronic sensing system including: a target gas sensor configured to detect a resistance of the target gas sensor; a reference sensor configured to detect a resistance of the reference sensor; a resistance comparator including a digital potentiometer, the resistance comparator being electrically connected to the target gas sensor and the reference sensor, wherein the digital potentiometer is configured to be adjusted to determine a first resistance in response to the resistance of the target gas sensor and a second resistance in response to the resistance of the reference sensor; and a system on a chip in electronic communication with the resistance comparator, the system on a chip being configured to determine a target gas concentration in response to the first resistance and the second resistance.

In addition to one or more of the features described above, or as an alternative, further embodiments may include a multiplexer electrically connecting the resistance comparator to the target gas sensor and the reference sensor, wherein the multiplexer includes: a first port electrically connected to the target gas sensor, a second port electrically connected to the reference sensor, and an output port electrically connected to the resistance comparator.

In addition to one or more of the features described above, or as an alternative, further embodiments may include that the system on a chip further includes general purpose input output in electronic communication with the multiplexer.

In addition to one or more of the features described above, or as an alternative, further embodiments may include a humidity sensor configured to detect an on-board humidity of the electronic sensing system.

In addition to one or more of the features described above, or as an alternative, further embodiments may include a temperature sensor configured to detect an on-board temperature of the electronic sensing system.

In addition to one or more of the features described above, or as an alternative, further embodiments may include that the system on a chip further includes an I2C in electronic communication with the humidity sensor.

In addition to one or more of the features described above, or as an alternative, further embodiments may include that the system on a chip further includes an I2C in electronic communication with the temperature sensor.

In addition to one or more of the features described above, or as an alternative, further embodiments may include that the system on a chip is configured to adjust the first resistance and the second resistance to compensate for the on-board humidity.

In addition to one or more of the features described above, or as an alternative, further embodiments may include that the system on a chip is configured to adjust the first resistance and the second resistance to compensate for the on-board temperature.

In addition to one or more of the features described above, or as an alternative, further embodiments may include that the system on a chip further includes an I2C in electronic communication with the resistance comparator.

In addition to one or more of the features described above, or as an alternative, further embodiments may include: a low pass filter; an amplifier; and an analog to digital converter, wherein the I2C is in electronic communication with the resistance comparator through the low pass filter, the amplifier, and the analog to digital converter.

In addition to one or more of the features described above, or as an alternative, further embodiments may include that the system on a chip further includes: a communication device configured to advertise a wireless signal.

In addition to one or more of the features described above, or as an alternative, further embodiments may include that the wireless signal is Bluetooth.

In addition to one or more of the features described above, or as an alternative, further embodiments may include that the communication device is configured to transmit the target gas concentration to an external device via the wireless signal.

In addition to one or more of the features described above, or as an alternative, further embodiments may include a thermistor configured to measure an off-board temperature, wherein the system on the chip is configured to adjust the on-board temperature in response to the off-board temperature.

In addition to one or more of the features described above, or as an alternative, further embodiments may include that the target gas is ethylene.

According to another embodiment, a method of detecting a target gas is provided. The method including: detecting a resistance of a target gas sensor; detecting a resistance of a digital potentiometer; adjusting the resistance of the digital potentiometer to a first resistance such that the first resistance of the digital potentiometer is matched to the resistance of the target gas sensor; detecting a resistance of a reference sensor; adjusting the resistance of the digital potentiometer to a second resistance such that the second resistance of the digital potentiometer is matched to the resistance of the target gas sensor; and determining target gas concentration in response to the first resistance and the second resistance.

In addition to one or more of the features described above, or as an alternative, further embodiments may include that prior to the determining the method further includes: detecting an on-board humidity using a humidity sensor; and adjusting the first resistance and the second resistance in response to the on-board humidity to compensate for the on-board humidity.

In addition to one or more of the features described above, or as an alternative, further embodiments may include that prior to the determining the method further includes: detecting an on-board temperature using a temperature sensor; and adjusting the first resistance and the second resistance in response to the on-board temperature to compensate for the on-board temperature.

In addition to one or more of the features described above, or as an alternative, further embodiments may include that prior to the determining the method further includes: detecting an on-board humidity using a humidity sensor; detecting an on-board temperature using a temperature sensor; and adjusting the first resistance and the second resistance in response to the on-board humidity and the on-board temperature to compensate for the on-board humidity and the on-board temperature.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

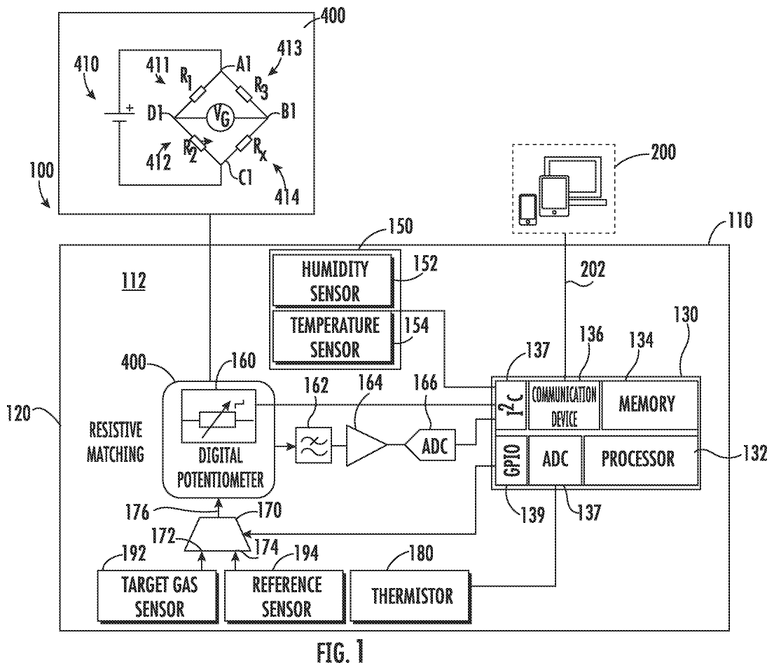

FIG. 1 illustrates a general schematic system diagram of an electronic sensing system, in accordance with an embodiment of the disclosure;

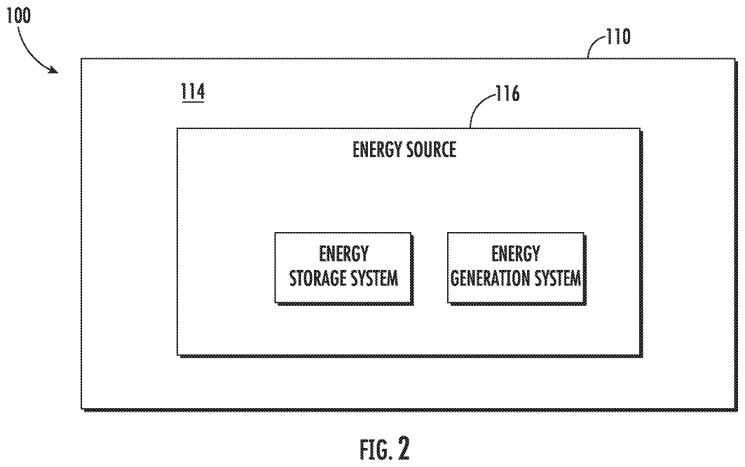

FIG. 2 illustrates a general schematic system diagram of an electronic sensing system, in accordance with an embodiment of the disclosure; and

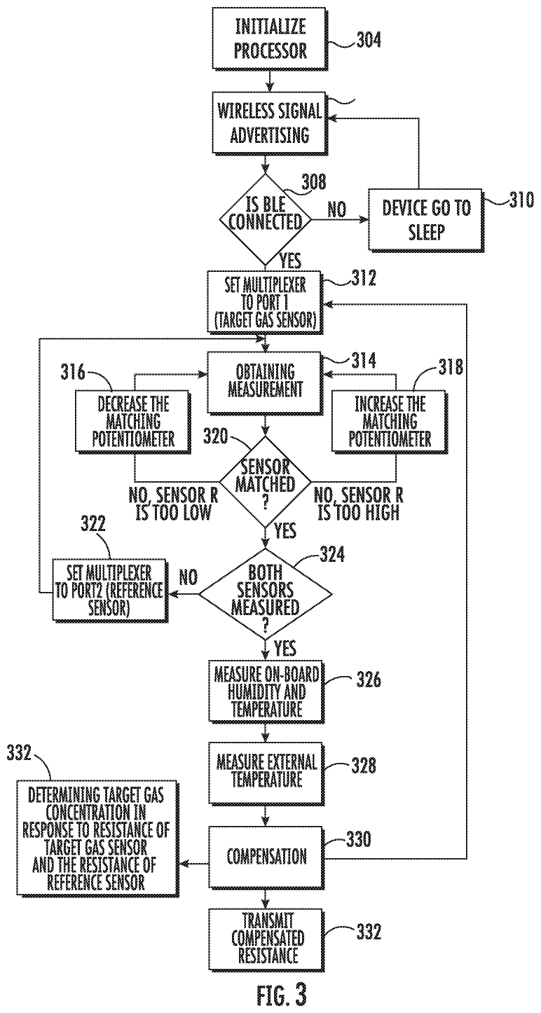

FIG. 3 is a flow diagram illustrating a method of detecting a target gas using the electronic sensing system of FIGS. 1-2, according to an embodiment of the present disclosure.

### DETAILED DESCRIPTION

A detailed description of one or more embodiments of the disclosed apparatus and method are presented herein by way of exemplification and not limitation with reference to the Figures.

The resistive response of a printed chemo-resistive gas sensor on a flexible substrate may be influenced by contaminants (e.g. other gases such as CO₂ and CO) as well as environmental conditions (e.g. humidity). As a result, real-world environmental conditions need to be carefully calibrated out since they may significantly influence the sensor's readings. Embodiments disclosed herein seek to provide an electronic sensing system capably of calibrating out contaminates to provide an accurate target gas reading.

FIGS. 1-2 schematically illustrates an electronic sensing system 100 configured to detect a target gas while adjusting for possible contaminates in the air. It should be appreciated that, although particular systems are separately defined in the schematic block diagrams, each or any of the systems may be otherwise combined or separated via hardware and/or software. The electronic sensing system 100 may be utilized in operative association with a transport refrigeration system, such as, for example, a refrigerated truck, a refrigerated trailer, or a refrigerated container. The electronic sensing system 100 may also be utilized in operative association with a commercial refrigeration system, such as, for example, refrigerated cabinets (e.g., self-serve refrigerated grocery cabinets with and without doors). In the transport refrigeration system or the commercial refrigeration system, the electronic sensing system 100 may be used as part of a refrigeration control system to adjust environmental conditions of the perishable goods (e.g., cargo/stock/inventory) in order to control, or influence the control of, ventilation, humidity, air temperature, and/or contaminant scrubbing systems. In one embodiment, the electronic sensing system 100 may be used to activate ventilation to lower the target gas concentration around the electronic sensing system 100, or to alert personnel to potential damage to perishable goods.

In another embodiment, the electronic sensing system 100 may be utilized independent of a corresponding refrigeration system or commercial refrigeration system to alert personnel to potential damage to perishable goods or to increase or decrease ventilation rates.

The electronic sensing system 100 includes a printed circuit board 110 having a first side 112 and a second side 114 opposite the first side 112. The printed circuit board 110 may be composed of multiple layers fiber glass and cooper in a non-limiting embodiment. A majority of the components 120 of the electronic sensing system 100 may be located on the first side 112 of the printed circuit board 110 and an energy source 116 may be located on the second side 114 of the printed circuit board 110. The energy source 116 may be electrically connected to the components 120 on the first side 112 of the printed circuit board 110 and provide electrical energy to the components 120 on the first side 112 of the printed circuit board 110.

The energy source 116 of the electronic sensing system 100 is configured supply electrical energy to the electronic sensing system 100. The energy source 116 of the electronic sensing system 100 is configured supply electrical energy to at least one component 120 on the first side 112 of the electronic sensing system 100. The energy source 116 of the electronic sensing system 100 may also be configured to store electrical energy an energy storage system 118, such as, for example, a battery system, capacitor, or other energy storage system known to one of skill in the art. The energy source 116 may also include an energy generation system 119 to generate electrical energy for the electronic sensing system 100. The energy generation system 119 may be an energy generation or electricity harvesting system, such as, for example, solar panel, radio frequency energy harvesting device, or other type of electrical generator known to one of skill in the art. In another embodiment, the energy source 116 may also be located on the first side 112 of the printed circuit board 110.

The electronic sensing system 100 may include a system on a chip 130, a sensor hub 150, a digital potentiometer 160, and a thermistor 180. The system on a chip 130 may comprise a processor 132, a memory 134, a communication device 136, an analog to digital convertor (ADC) 137, I²C 138, and a general purpose input output (GPIO). In an embodiment, the processor 132 may be a 32 bit reduced instruction set computer processor. In an embodiment, the memory 134 is a 512 kB flash memory. The ADC 137 may be a 12 bit ADC. In an embodiment, the communication device 136 may a 2.4 GHZ radio. The communication device 136 may be capable of transmitting wireless signals 202 to an external device 200. The wireless signals 202 may be long-range wireless (e.g., LORA) or short-range wireless (e.g., Bluetooth). The communication device 136 may be configured to transmit a target gas concentration to the external device 200 via the wireless signal 202.

The external device 200 may be a computing device capable of doing real-time analysis, such as, for example, a desktop computer, a laptop computing, a tablet computer, a smart phone, a smart watch, or similar computing device known to one of skill in the art. Although not shown for simplification, the external device 200 may include a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The ADC 137 may electrically connect the system on a chip 130 to the thermistor 180. The thermistor 180 is configured to measure the external temperature of the electronic sensing system 100. The thermistor 180 may be a negative temperature coefficient (NTC) temperature-sensing elements that are off board (connected to the actual printed chemo-resistive gas sensor via wires) to measure the temperature of the sensor for calibration. The thermistor 180 may be configured to measure an off-board temperature. Whereas the temperature sensor 154 may be mounted on the printed circuit board 110 and may be used for measuring a temperature of the printed circuit board 110 for compensating thermal drift of the onboard electrical components.

The I²C 138 may electrically connect the system on a chip 130 to the on-board sensor hub 150. The on-board sensor hub 150 may include a humidity sensor 152 and a temperature sensor 154. The humidity sensor 152 is configured to detect on-board humidity of air proximate and/or within the electronic sensing system 100. The temperature sensor 154 is configured to detect on-board temperature of air proximate and/or within the electronic sensing system 100.

The GPIO 139 may electrically connect the system on a chip 130 to a multiplexer 170 having two inputs 172, 174 and one output 176. The two inputs of the multiplexer 170 may be a target gas sensor 192 and a reference sensor 194. The target gas sensor 192 is configured to detect a target gas. The target gas may be organic gas molecules or inorganic gas molecules. Organic gas molecules may include, but are not limited to, ethylene, formaldehyde, methane, propene, any particular or total volatile organic compound (VOC) count, any particular or total alcohol count, any particular or total aromatic compound count, . . . etc. Inorganic gas molecules may include, but are not limited to, O₂, CO, CO₂, ammonia (NH₃), SH₂, . . . etc. In an embodiment, the target gas may be ethylene. The target gas sensor 192 and the reference sensor 194 may be similar. For example the reference sensor 194 a similar printed chemo-resistive sensor to the target gas sensor 192 but without the gas sensing chemicals included in the target gas sensor 192. The reference sensor 194 may have a similar response to a contaminant (e.g., CO and CO2) with the target gas sensor 192 but the reference sensor 194 will have no response to the target gas. Therefore, a reading from the reference sensor 192 could be used for eliminating the influence caused by a contaminant (CO and CO2).

The target gas sensor 192 is electrically connected to the multiplexer 170 through a first port 172 and the reference sensor 194 is electrically connected to the multiplexer 170 through a second port 174 The output 176 of the multiplexer 170 is electrically connected to a digital potentiometer 160 and the digital potentiometer 160 may be electrically connected to the I²C 138 through a low pass filter 162, an amplifier 164, and an analog to digital converter 166.

The digital potentiometer 160 may be a second resistor 412 within a resistance comparator 400. The resistance comparator may be a Wheatstone bridge, a Kelvin bridge, an ohm meter, or any similar device known to one of skill in the art. In an embodiment, the resistance comparator 400 may be a Wheatstone bridge. The resistance comparator may comprise a power source 410, first junction A1, a second junction C1, a first mid-junction B1, a second mid junction D1, a first resistor 411, a second resistor 412, a third resistor 413, a fourth resistor 414, and a galvanometer 420. The first resistor 411 may have a known resistance of R₁. The second resistor 412 may have a known resistance of R₂. The third resistor 413 may have a known resistance of R₃. The fourth resistor 414 may have an unknown resistance of R_{X}. The target gas sensor 192 may be the fourth resistor 414 of the resistance comparator 400. The resistance comparator 400 may be used to adjust the resistance the resistance R₂ of the second resistor 412 (i.e., the digital potentiometer 160) such that the resistance R₂ of the second resistor 412 (i.e., the digital potentiometer 160) matches the resistance Rₓ of the fourth resistor (i.e., the target gas sensor 192) as close as possible. Until the resistance R₂ of the second resistor 412 (i.e., the digital potentiometer 160) matches the resistance Rₓ of the fourth resistor (i.e., the target gas sensor 192) the galvanometer 420 may produce a voltage V_{G}, which may be amplified by the amplifier 164 to more precisely adjust the resistance R₂ of the second resistor 412 (i.e., the digital potentiometer 160). Referring now to FIG. 3, with continued reference to FIGS. 1-2, a method, a flow chart of a method 300 of detecting a target gas illustrated, in accordance with an embodiment of the present disclosure. In an embodiment, the target gas may be ethylene. In an embodiment, the method 300 is performed by the electronic sensing system 100. At block 304, the processor 132 is initialized and the method 300 is initiated

At block 306, the communication device 136 initiates advertisement of the wireless signal 202. The communication device 136 may be configured to continuously advertise a wireless signal 202 once imitated at block 306. The advertisement is the communication device 136 declaring its presence to any nearby listening external device 200 and if it is a connectable advertisement it is an opportunity for external device 200 to connect to the communication device 136. For example, the wireless signal 202 of the communication device 136 may be a Bluetooth signal. The external device 200 is configured to detect the wireless signal 202 and connect to the communication device 136. At block 308, it is determined whether the communication device 136 has connected to an external device 200 via the wireless signal 202. If at block 308, it is determined that the communication device 136 has not connected to an external device 200 via the wireless signal 202 then the method 300 moves to block 310 and the processor 132, the ADC 137, the sensor hub 150, and the thermistor 180 go to sleep. If at block 308, it is determined that the communication device 136 has connected to an external device 200 via the wireless signal 202 then the method 300 moves to block 312 and the multiplexer 170 is set to a first port 172 that is in electric communication with the target gas sensor 192.

At block 314, a target gas measurement is obtained using the target gas sensor 192 through the ADC 166. The target gas measurement is detected by the target gas sensor 192 through a resistance measurement taken by the target gas sensor 192. The resistance measurement of the target gas sensor 192 will change if the target gas concentration has changed.

At block 320, it is determined whether the resistance of the target gas sensor 192 captured during the target gas measurement is matched to with a resistance of the digital potentiometer 160 If at block 320, the resistance of the target gas sensor 192 captured during the target gas measurement is matched then the method 300 moves to block 320. If at block 320, the resistance of the target gas sensor 192 captured during the target gas measurement is not matched then the method 300 moves to block 316 if the resistance is too low or to block 318 if the resistance is too high. At block 318, the digital potentiometer 160 is increased if the resistance is too high. At block 316, the digital potentiometer 160 is decreased if the resistance is too low.

Once the resistance of the target gas sensor 192 captured during the target gas measurement is matched at block 320 the method 300 then moves onto block 322 to check whether the reference sensor 194 is matched with a resistance of the digital potentiometer 160. At block 322, the multiplexer 170 is set to a second port 174 that is in electric communication with the reference sensor 194.

At block 314, a measurement is obtained using the ADC 166 and the reference sensor 194. The measurement is detected by the reference sensor 194 through a resistance measurement taken by the reference sensor 194

At block 320, it is determined whether the resistance of the reference sensor 194 captured during the reference measurement is matched to the resistance of the digital potentiometer 160. If at block 320, the resistance of the reference sensor 194 captured during the reference measurement is matched then the method 300 moves to block 320. If at block 320, the resistance of the reference sensor 194 captured during the reference measurement is not matched then the method 300 moves to block 316 if the resistance is too low or to block 318 if the resistance is too high. At block 318, the digital potentiometer 160 is increased if the resistance is too high. At block 316, the digital potentiometer 160 is decreased if the resistance is too low.

Once the resistance of the reference sensor 194 captured during the reference measurement is matched at block 320 the method 300 then moves onto block 322 where both resistance of the reference sensor 194 and the resistance of the target gas sensor 192 should be now both be matched. At block 326, the on-board humidity is measured by the humidity sensor 152 and the on-board temperature is measured by the temperature sensor 154. The reference sensor 194 and the target gas sensor 192 should respond the same to humidity and temperature changes.

At block 328, the external temperature is measured by the thermistor 180.

At block 330, a compensation is applied to the resistance captured by the target gas sensor 192 and the resistance captured by the reference sensor 194. Both the target gas sensor 192 and the reference sensor 194 are pre-calibrated based on the on-board humidity measured by the humidity sensor 152, the on-board temperature measured by the temperature sensor 154 and the external temperature measured by the thermistor 180. Ideally the reference sensor 194 and the target gas sensor 192 should have the same response to humidity and temperature but may differ in real life due to the effects of the sensing chemicals and the fact that the printed substrates may not be exactly identical. From testing, the resistance response of the reference sensor 194 and the target gas sensor 192 with humidity and temperature may often be much higher than the resistance response of the reference sensor 194 and the target gas sensor 192 to the target gas. Therefore it may be necessary to compensate the readings of the reference sensor 194 and the target gas sensor 192 by the humidity detected by the humidity sensor 152 and the temperature detected by the temperature sensor 154.

At block 332, the compensated resistance is then transmitted back to the external device 200 and the method may move back to block 312 to capture more resistance measurements.

At block 334, the target gas concentration is determined in response to the resistance of the target gas sensor 194 and the resistance of the reference sensor 194. For example, since the reference sensor 194 detects contaminates but not the target gas, while the target gas sensor 194 detects the target gas and contaminates, the combination of the resistance of the target gas sensor 194 and the resistance of the reference sensor 194 may be used to determine resistance. The resistance of the target gas sensor 192 used in determining the target gas concentration may be the compensated resistance, as described in block 330. The resistance of the reference sensor 194 used in determining the target gas concentration may be the compensated resistance, as described in block 330.

While the above description has described the flow processes of FIG. 3 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electronic sensing system located on a printed circuit board for detecting a target gas, the electronic sensing system comprising:
a target gas sensor configured to detect a resistance of the target gas sensor;
a reference sensor configured to detect a resistance of the reference sensor;
a resistance comparator including a digital potentiometer, the resistance comparator being electrically connected to the target gas sensor and the reference sensor, wherein the digital potentiometer is configured to be adjusted to determine a first resistance in response to the resistance of the target gas sensor and a second resistance in response to the resistance of the reference sensor; and
a system on a chip in electronic communication with the resistance comparator, the system on a chip being configured to determine a target gas concentration in response to the first resistance and the second resistance.

2. The electronic sensing system of claim 1, further comprising:
a multiplexer electrically connecting the resistance comparator to the target gas sensor and the reference sensor, wherein the multiplexer comprises: a first port electrically connected to the target gas sensor, a second port electrically connected to the reference sensor, and an output port electrically connected to the resistance comparator.

3. The electronic sensing system of claim 2, wherein the system on a chip further comprises general purpose input output in electronic communication with the multiplexer.

4. The electronic sensing system of claim 1, further comprising:
a humidity sensor configured to detect an on-board humidity of the electronic sensing system.

5. The electronic sensing system of claim 1, further comprising:
a temperature sensor configured to detect an on-board temperature of the electronic sensing system.

6. The electronic sensing system of claim 4, wherein the system on a chip further comprises an I²C in electronic communication with the humidity sensor.

7. The electronic sensing system of claim 5, wherein the system on a chip further comprises an I²C in electronic communication with the temperature sensor.

8. The electronic sensing system of claim 4, wherein the system on a chip is configured to adjust the first resistance and the second resistance to compensate for the on-board humidity.

9. The electronic sensing system of claim 5, wherein the system on a chip is configured to adjust the first resistance and the second resistance to compensate for the on-board temperature.

10. The electronic sensing system of claim 1, wherein the system on a chip further comprises an I²C in electronic communication with the resistance comparator.

11. The electronic sensing system of claim 10, further comprising:
a low pass filter;
an amplifier; and
an analog to digital converter,
wherein the I²C is in electronic communication with the resistance comparator through the low pass filter, the amplifier, and the analog to digital converter.

12. The electronic sensing system of claim 1, wherein the system on a chip further comprises:
a communication device configured to advertise a wireless signal.

13. The electronic sensing system of claim 12, wherein the wireless signal is Bluetooth.

14. The electronic sensing system of claim 12, wherein the communication device is configured to transmit the target gas concentration to an external device via the wireless signal.

15. The electronic sensing system of claim 5, further comprising:
a thermistor configured to measure an off-board temperature, wherein the system on the chip is configured to adjust the on-board temperature in response to the off-board temperature.

16. The electronic sensing system of claim 1, wherein the target gas is ethylene.

17. A method of detecting a target gas, the method comprising:
detecting a resistance of a target gas sensor;
detecting a resistance of a digital potentiometer;
adjusting the resistance of the digital potentiometer to a first resistance such that the first resistance of the digital potentiometer is matched to the resistance of the target gas sensor;
detecting a resistance of a reference sensor;
adjusting the resistance of the digital potentiometer to a second resistance such that the second resistance of the digital potentiometer is matched to the resistance of the target gas sensor; and
determining target gas concentration in response to the first resistance and the second resistance.

18. The method of claim 17, wherein prior to the determining the method further comprises:
detecting an on-board humidity using a humidity sensor; and
adjusting the first resistance and the second resistance in response to the on-board humidity to compensate for the on-board humidity.

19. The method of claim 17, wherein prior to the determining the method further comprises:
detecting an on-board temperature using a temperature sensor; and
adjusting the first resistance and the second resistance in response to the on-board temperature to compensate for the on-board temperature.

20. The method of claim 17, wherein prior to the determining the method further comprises:
detecting an on-board humidity using a humidity sensor;
detecting an on-board temperature using a temperature sensor; and
adjusting the first resistance and the second resistance in response to the on-board humidity and the on-board temperature to compensate for the on-board humidity and the on-board temperature.
